(19) United States
(12) Patent Application Publication
(10) Pub. No.: US 2001/0047492 A1
(43) Pub. Date: Nov. 29, 2001

(54) Uninterruptible power supply for automatically storing computer data in hard disk when halting

(76) Inventors: Chia-Chi Tsui, Taipei (TW); Tung-Chou Hsieh, Taipei (TW)

Correspondence Address: BACON & THOMAS, PLLC, 4th Floor, 625 Slaters Lane, Alexandria, VA, 22314-1176, US

(21) Appl. No.: 09/852,045

(22) Filed: May 10, 2001

(30) Foreign Application Priority Data
May 23, 2000 (TW) 089109909

(51) Int. Cl. G06F 1/26; G06F 1/32

(52) U.S. Cl. 713/320

(57) ABSTRACT

An uninterruptible power supply (UPS) is electrically coupled to a main board, a hard disk and a power supply of the computer. The UPS comprises a power detection circuit for detecting a power supplying state of the power supply when the computer is halting, a power management circuit for receiving a blackout signal sent from the power detection circuit when a blackout in the power supply is detected, and a power switch circuit is commanded by the power management circuit to switch power of the main board and the hard disk from the power supply to the rechargeable battery for maintaining a normal operation. At the same time, the power management circuit sends a power ready signal to the main board through a power switch on the main board to cause CPU to boot the computer normally and the CPU commands to store temporary data and programs in the memory in the hard disk. Such safely stored data and programs may be retrieved from hard disk by CPU for use when computer is powered on again. Hence, computer may be normally operated.

### FIELD OF THE INVENTION

The present invention relates to uninterruptible power supplies (UPSs) and more particularly to a UPS for automatically storing computer data in hard disk when halting.

### BACKGROUND OF THE INVENTION

It is not unusual for the occurring of blackout especially in high peak time such as summer season. As known that once the line is overloaded the generator may trip. Such sudden blackout may cause damage to some types of electrical devices such as computers in use because data may be lost. A UPS for automatically storing data is commercially available wherein UPS is coupled to computer and supplies power to main board, hard disk and power supply installed therein. When power detection circuit detects a blackout in a running computer, the power detection circuit will send a blackout signal to power management circuit. Thus power management circuit is enabled to control a power switch circuit for switching power of computer to a backup battery in real time. Hence, a central processing unit (CPU) may store data and programs of the running computer in hard disk immediately. Such safely stored data and programs may be retrieved from hard disk by CPU for use when computer is powered on again. Hence, user may normally operate the computer.

It is also known that a halt program is installed in a window-based UPS. When computer is halting, the halt program may be executed to command CPU to store running data and programs in memory temporarily. Further, a certain circuit designed in computer is activated to supply power directly to some of units therein (such as memory and BIOS), and shut down power to main board, hard disk and UPS concurrently. This can save energy. However, the previous UPS suffered from a disadvantage. For example, it is impossible for the UPS to determine whether computer is halting. Hence, when blackout occurs a computer equipped with such UPS is not able to transfer data and programs temporarily stored in memory into hard disk within a permissible period of time. This may cause data and programs lost. Thus, improvement exists.

### SUMMARY OF THE INVENTION

It is an object of the present invention to provide an uninterruptible power supply (UPS) apparatus in a computer. The UPS apparatus is electrically coupled to a main board, a hard disk and a power supply of the computer and comprises a memory, a rechargeable battery, a power detection circuit for detecting a power supplying state of the power supply when the computer is halting, a power management circuit for receiving a blackout signal sent from the power detection circuit when a blackout in the power supply is detected, and a power switch circuit is commanded by the power management circuit to switch power of the main board and the hard disk from the power supply to the rechargeable battery for maintaining a normal operation wherein at the same time the power management circuit sends a power ready signal to the main board through a power switch on the main board to cause CPU to boot the computer normally and the CPU commands to store temporary data and programs in the memory into the hard disk. Such safely stored data and programs may be retrieved from hard disk by CPU for use when computer is powered on again. Hence, computer may be normally operated.

The above and other objects, features and advantages of the present invention will become apparent from the following detailed description taken with the accompanying drawings.

### BRIEF DESCRIPTION OF THE DRAWINGS

FIG. 1 is a block diagram of UPS incorporated in a UPS according to the invention; and

FIG. 2 is a flow chart illustrating the operation of FIG. 1 UPS.

### DETAILED DESCRIPTION OF THE PREFERRED EMBODIMENTS

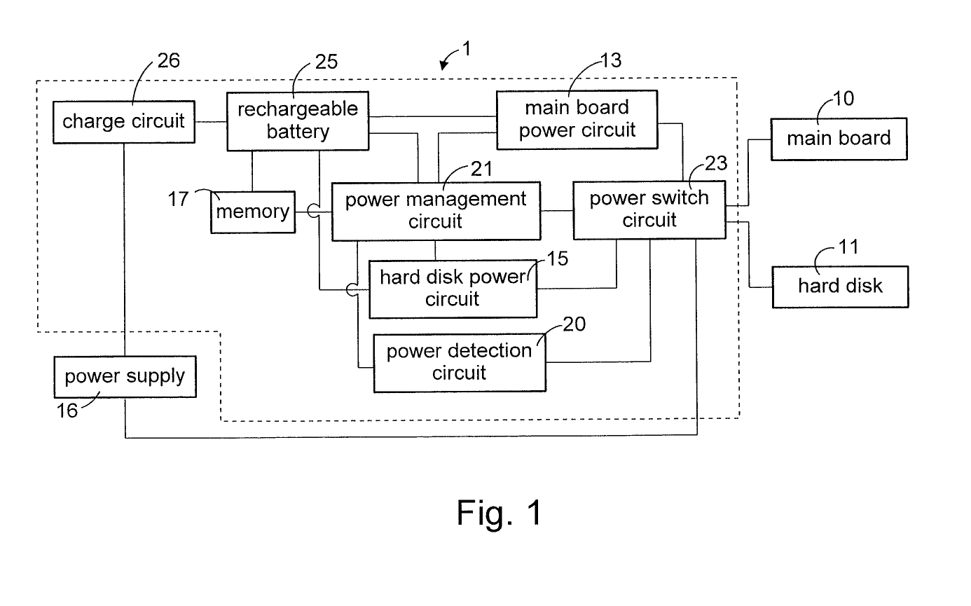

Referring to FIG. 1, there is shown a UPS 1 constructed in accordance with the invention. UPS 1 is installed in computer. UPS 1 is powered by a power supply 16 which converts externally supplied AC into DC usable by computer in normal condition. Further, UPS 1 interconnects a main board 10 and a hard disk 11 for supplying DC thereto. When UPS 1 detects a blackout of power supply 16, UPS 1 will be immediately switched to supply power to main board 10 and hard disk 11 (i.e., as a backup) for maintaining a normal operation. Further, CPU of computer 10 is commanded to store running data and programs (or other data and programs stored in memory temporarily) in hard disk 11. This can prevent running data and programs from being lost due to blackout.

As shown, UPS 1 comprises a charge circuit 26, a rechargeable battery (e.g., seven serially connected nickel hydrogen (Ni—MH) cells) 25, a memory 17, a main board power circuit 13, a hard disk power circuit 15, a power management circuit 21, a power switch circuit 23, and a power detection circuit 20. Charge circuit 26 interconnects power supply 16 and rechargeable battery 25. Hence, DC may be supplied from power supply 16 to rechargeable battery 25 (i.e., charging) through charge circuit 26. Rechargeable battery 25 is coupled to memory 17 for supplying power when a blackout occurs. Rechargeable battery 25 is also coupled to main board power circuit 13 and hard disk power circuit 15 respectively for supplying power thereto for maintaining a normal operation when a blackout occurs. In the invention, UPS 1 utilizes power detection circuit 20 to detect the power supplying state of power supply 16. Once a blackout in power supply 16 is detected, a blackout signal is sent to power management circuit 21 in real time. Power management circuit 21 is thus commanded to cause power switch circuit 23 to switch power of main board 10 and hard disk 11 from power supply 16 to main board power circuit 13 and hard disk power circuit 15 which are powered by rechargeable battery 25 for maintaining a normal operation thereof. At the same time, power management circuit 21 is commanded by computer to store running data and programs (or other data and programs stored in memory 17 temporarily) in hard disk 11. Such safely stored data and programs may be retrieved from hard disk 11 by CPU for use when computer is powered on again. Hence, user may normally operate computer. Again, once normal power in power supply 16 is detected by power detection circuit 20, power switch circuit 23 is commanded to switch power of main board 10 and hard disk 11 from UPS 1 to power supply 16 for maintaining a normal operation of main board power circuit 13 and hard disk power circuit 15.

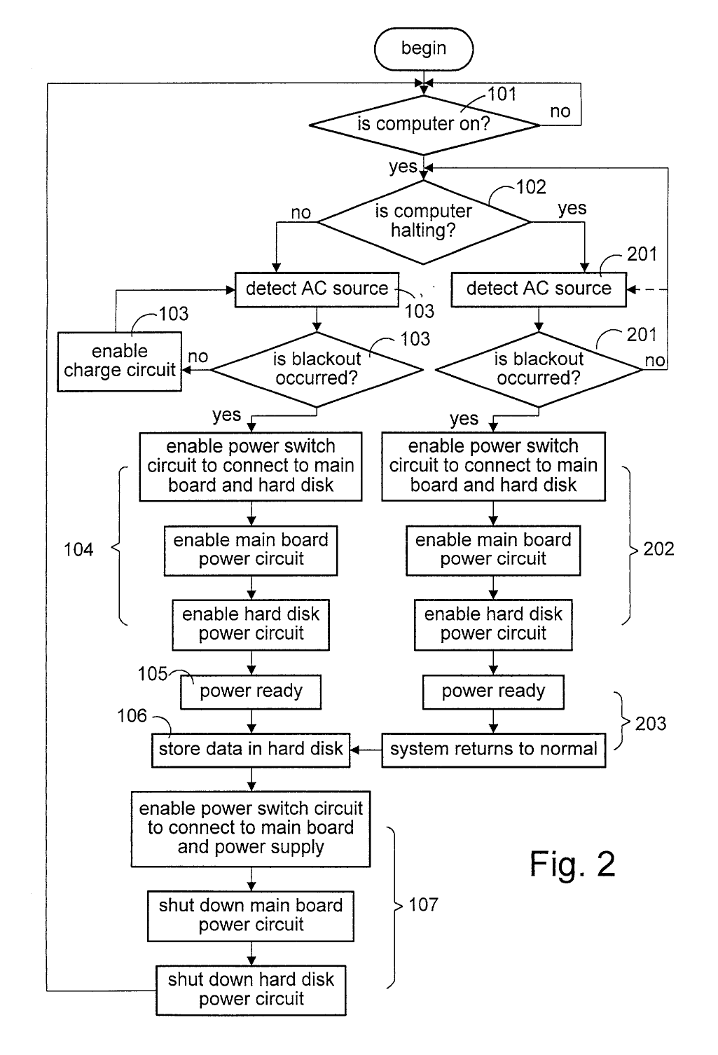

Referring to FIG. 2, a process with respect to a detection and switch of computer power by UPS 1 of the invention is illustrated below.

In step 101, a basic input/output system (BIOS) of computer is enabled to detect whether computer is powered. If yes, process goes to step 102. If not, process continues to detect in step 101.

In step 102, BIOS determines whether computer is halting. If yes, process goes to step 201. If not, process continues to step 103.

In step 103, process detects whether power supply 16 is normal (i.e., AC supplied from external source). If yes, charge circuit 26 is enabled by power management circuit 21 to command power supply 16 to charge the rechargeable battery 25 through charge circuit 26. This step will continue until a blackout is detected in power supply 16.

In step 104, power detection circuit 20 sends a blackout signal to power management circuit 21 in real time. Power management circuit 21 is thus commanded to cause power switch circuit 23 to switch power of main board 10 and hard disk 11 from power supply 16 to main board power circuit 13 and hard disk power circuit 15 which are powered by rechargeable battery 25 for maintaining a normal operation thereof.

In step 105, power management circuit 21 sends a power ready signal to main board 10 through power switch on main board 10.

In step 106, CPU on main board 10 commands to store running data and programs in memory 17 into hard disk 11.

In step 107, CPU sends a storing completion signal to power management circuit 21 through the power switch on main board 10. Power switch circuit 23 is commanded by power management circuit 21 to switch power of main board 10 to power supply 16 again and shut down main board power circuit 13 and hard disk power circuit 15 through the power switch on main board 10 for disabling computer. Finally, process loops back to step 101.

In step 201, process detects whether power supply 16 is normal (i.e., AC supplying from external source). If yes, process goes back to step 102. If not, process goes to step 202.

In step 202, power detection circuit 20 sends a blackout signal to power management circuit 21 in real time. Power management circuit 21 is thus commanded to cause power switch circuit 23 to switch power of main board 10 and hard disk 11 from power supply 16 to main board power circuit 13 and hard disk power circuit 15 which are powered by rechargeable battery 25 for maintaining a normal operation thereof.

In step 203, power management circuit 21 sends a power ready signal to main board 10 through power switch on main board 10. Further, CPU on main board 10 commands to enable main board 10, hard disk 11 and power supply 16 to operate normally through power switch of main board 10. Finally, process goes to step 106 to continue.

In brief, such safely stored data and programs may be retrieved from hard disk 11 by CPU for use when computer is powered on again. Hence, computer may be normally operated.

While the invention has been described by means of specific embodiments, numerous modifications and variations could be made thereto by those skilled in the art without departing from the scope and spirit of the invention set forth in the claims.

What is claimed is:

1. An uninterruptible power supply (UPS) apparatus provided in a computer, said UPS apparatus being electrically coupled to a main board, a hard disk and a power supply of said computer and comprising a memory, a rechargeable battery, a power detection circuit for detecting a power supplying state of said power supply when said computer is halting, a power management circuit for receiving a blackout signal sent from said power detection circuit when a blackout in said power supply is detected, and a power switch circuit is commanded by said power management circuit to switch power of said main board and said hard disk from said power supply to said rechargeable battery for maintaining a normal operation wherein at the same time said power management circuit sends a power ready signal to said main board through a power switch on said main board to cause a central processing unit (CPU) on said main board to boot said computer normally and said CPU commands to store temporary data and programs in said memory in said hard disk.

2. The UPS apparatus of claim 1, wherein when said blackout in said power supply of said computer in running is detected said power detection circuit sends said blackout signal to said power management circuit to cause said power switch circuit to switch power of said computer from said power supply to said rechargeable battery, at the same time said power management circuit sends said power ready signal to said main board through a power switch on said main board to cause said CPU on said main board to command to store running data and programs in said hard disk.

3. The UPS apparatus of claim 2, wherein said UPS apparatus further comprises a charge circuit when a normal power in said power supply is detected by said power detection circuit, said power supply is commanded by said power switch circuit to enable said charge circuit for charging said rechargeable battery.

4. The UPS apparatus of claim 3, wherein said UPS apparatus further comprises a main board power circuit and a hard disk power circuit both electrically coupled to said rechargeable battery when said blackout in said power supply is detected said power detection circuit sends said blackout signal to said power management circuit to cause said power switch circuit to switch power of said main board and said hard disk from said power supply to said main board power circuit and said hard disk power circuit for maintaining said normal operation.

5. The UPS apparatus of claim 4, wherein when both said main board and said hard disk are powered by said rechargeable battery said power management circuit sends said power ready signal to said main board through said power switch on said main board to cause said CPU to command to store running data and programs in said memory in said hard disk.

6. The UPS apparatus of claim 5, wherein after running data and programs in said memory have been stored in said hard disk, said CPU sends a storing completion signal to said power management circuit through said power switch on said main board to cause said power switch circuit to switch power of said main board to said power supply again and shut down said main board power circuit and said hard disk power circuit through said power switch on said main board for disabling said computer.

7. The UPS apparatus of claim 1, wherein when said blackout in said power supply is detected said power detection circuit sends said blackout signal to said power management circuit to cause said power switch circuit to switch power of said main board and said hard disk from said power supply to said main board power circuit and said hard disk power circuit for maintaining said normal operation.

8. The UPS apparatus of claim 7, wherein when both said main board and said hard disk are powered by said rechargeable battery said power management circuit sends said power ready signal to said main board through said power switch on said main board to cause said CPU to enable said halting main board, said hard disk, and said power supply to operate normally and store running data and programs in said memory in said hard disk.

9. The UPS apparatus of claim 8, wherein after running data and programs in said memory have been stored in said hard disk, said CPU sends said storing completion signal to said power management circuit through said power switch on said main board to cause said power switch circuit to switch power of said main board to said power supply again and shut down said main board power circuit and said hard disk power circuit through said power switch on said main board for disabling said computer.

10. The UPS apparatus of claim 7, wherein as long as said normal power in said power supply is detected, said power detection circuit continues said detection.
